(19) United States
(12) Patent Application Publication
(10) Pub. No.: US 2013/0224599 A1
(43) Pub. Date: Aug. 29, 2013

(54) NEGATIVE ACTIVE MATERIAL FOR RECHARGEABLE LITHIUM BATTERY, METHOD OF PREPARING THE SAME, AND RECHARGEABLE LITHIUM BATTERY INCLUDING THE SAME

(71) Applicant: UNIST Academy-Industry Research Corporation, (US)

(72) Inventors: Soojin PARK, Ulsan (KR); Byoungman BANG, Gyeongsan-si (KR); Hyun-Kon SONG, Ulsan (KR); Jaephil CHO, Suwon-si (KR); Hyun-Jung KIM, Daegu (KR)

(73) Assignee: UNIST Academy-Industry Research Corporation, Ulsan (KR)

(21) Appl. No.: 13/855,798

(22) Filed: Apr. 3, 2013

Related U.S. Application Data
(63) Continuation of application No. PCT/KR2010/008764, filed on Dec. 8, 2010.

(30) Foreign Application Priority Data
Oct. 4, 2010 (KR) 10-2010-0096575

(51) Int. Cl. H01M 4/1393; H01M 4/133; H01M 4/04

(52) U.S. Cl. CPC H01M 4/1393; H01M 4/0402; H01M 4/133
USPC 429/231.8; 216/13; 429/209

(57) ABSTRACT

Disclosed are a method of preparing a negative active material for a rechargeable lithium battery that includes: preparing a powder including a material being capable of doping and dedoping lithium; coating the powder including the material being capable of doping and dedoping lithium with metal particles; and etching the powder including the material being capable of doping and dedoping lithium and coated with the metal particles, a negative active material for a rechargeable lithium battery prepared in this method, and a rechargeable lithium battery including the negative active material.

### CROSS-REFERENCE TO RELATED APPLICATION

This application is a Continuation application of an International Application of PCT/KR2010/008764 filed on Dec. 8, 2010, which claims priority to and the benefit of Korean Patent Application No. 10-2010-0096575 filed in the Korean Intellectual Property Office on Oct. 4, 2010, the entire contents of which are incorporated herein by reference.

### BACKGROUND OF THE INVENTION

(a) Field of the Invention

This disclosure relates to a negative active material for a rechargeable lithium battery, a method of preparing the same, and a rechargeable lithium battery including the same.

(b) Description of the Related Art

Batteries generate electrical power by using a material being capable of an electrochemical reaction at positive and negative electrodes. Rechargeable lithium batteries generate electrical energy from changes of chemical potential during intercalation/deintercalation of lithium ions at the positive and negative electrodes.

The rechargeable lithium batteries include a material that reversibly intercalates or deintercalates lithium ions during the charge and discharge reactions for both positive and negative active materials, and also include an organic electrolyte or a polymer electrolyte between the positive and negative electrodes.

As for the positive active material for a rechargeable lithium battery, a composite metal oxide such as LiCoO₂, LiMn₂O₄, LiNiO₂, LiNi₁₋ₓCoₓO₂ (0<x<1), LiMnO₂, LiFePO₄, and so on, has been researched.

As for the negative active material of a rechargeable lithium battery, various carbon-based materials such as artificial graphite, natural graphite, and hard carbon, which can all intercalate and deintercalate lithium ions, have been used. Since graphite among the carbon-based materials has a low discharge potential relative to lithium of −0.2V, a battery using the graphite as a negative active material has a high discharge potential of 3.6V and excellent energy density. Furthermore, graphite guarantees a long cycle life for a battery due to its outstanding reversibility. However, a graphite active material has a low density of 1.6 g/cc and consequently has a low capacity in terms of energy density per unit volume when the graphite is used as a negative active material.

In order to solve these problems, a great deal of research on a high-capacity negative active material has recently been performed.

### SUMMARY OF THE INVENTION

One aspect of the present invention provides a method of preparing a negative active material for a rechargeable lithium battery, which has excellent processing and economy by including etching using metal particles as a catalyst.

Another aspect of the present invention provides a negative active material for a rechargeable lithium battery prepared in the method, including a nanostructure and pores, and thus has a big specific surface area and mitigates volume change during the charge and discharge.

Yet another aspect of the present invention provides a rechargeable lithium battery including the negative active material.

According to one aspect of the present invention, a method of preparing a negative active material for a rechargeable lithium battery is provided, which includes: providing a powder including a material being capable of doping and dedoping lithium; coating the powder including the material being capable of doping and dedoping lithium with metal particles; and etching the powder including the material being capable of doping and dedoping lithium and coated with the metal particles.

The method may further comprise coating the etched powder including the material being capable of doping and dedoping lithium with carbon.

The material being capable of doping and dedoping lithium may include one selected from the group consisting of silicon (Si), a Si—Y₁ alloy, tin (Sn), a Sn—Y₂ alloy, antimony (Sb), germanium (Ge), lead (Pb), and a combination thereof (wherein Y₁ and Y₂ are the same or different and are selected from the group consisting of an alkali metal, an alkaline-earth metal, a group 13 element, a group 14 element, transition elements, a rare earth element, and a combination thereof), provided that Y₁ is not silicon (Si) and Y₂ is not tin (Sn).

Examples of Y₁ and Y₂ may include one selected from the group consisting of magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), silicon (Si), tin (Sn), indium (In), germanium (Ge), phosphorus (P), arsenic (As), antimony (Sb), bismuth (Bi), sulfur (S), selenium (Se), tellurium (Te), polonium (Po), and a combination thereof.

The powder including a material being capable of doping and dedoping lithium may have an average particle diameter ranging from about 500 nm to about 100 μm.

The powder including the material being capable of doping and dedoping lithium may be coated with metal particles in an electroless plating method, a physical vapor deposition (PVD) method, a chemical vapor deposition (CVD) method, a thermal evaporation method, an e-beam evaporation method, a sputtering method, a method using an organic capping agent, or a combination thereof.

The metal particles may include gold, silver, platinum, copper, nickel, aluminum, or a combination thereof.

The metal particles may have an average particle diameter ranging from about 1 nm to about 100 nm.

The powder including the material being capable of doping and dedoping lithium and coated with the metal particles may be etched by using a mixed solution of hydrogen peroxide and fluorinated hydrogen, a hydrogen peroxide solution, a fluorinated hydrogen solution, a potassium hydroxide (KOH) solution, a mixed solution of potassium hydroxide (KOH) and isopropyl alcohol (IPA), or a combination thereof.

In particular, the hydrogen peroxide may include a hydrogen peroxide aqueous solution with a concentration ranging about 0.2% to about 10%. The fluorinated hydrogen may include a fluorinated hydrogen aqueous solution with a concentration ranging from about 0.1% to about 20%.

According to another aspect of the present invention, provided is a negative active material for a rechargeable lithium battery prepared in the method.

A negative active material for a rechargeable lithium battery may include: a core including a material being capable of doping and dedoping lithium; a nanostructure formed on the surface of the core and including a material being capable of doping and dedoping lithium; and pores in the core, the nanostructure, among the nanostructures, or a combination thereof.

The negative active material may further include a carbon coating layer formed on the surface of the nanostructure, the pores, or a combination thereof.

The nanostructure may include nanowire, nanorods, nanotubes, nanoparticles, or a combination thereof.

The nanostructure may have an aspect ratio ranging from about 1 to about 10,000. In addition, the nanostructure may have a length ranging from about 100 nm to about 30 μm and an average diameter ranging from about 1 nm to about 500 nm.

In the negative active material for a rechargeable lithium battery, the pores formed in a core and a nanostructure may have an average diameter ranging from about 1 nm to about 100 nm. The pores among nanostructures may have an average diameter ranging from about 100 nm to about 2 μm.

In the negative active material for a rechargeable lithium battery, the pores may include nanopores with an average diameter ranging from about 1 nm to about 500 nm and micropores with an average diameter ranging from about 500 nm to about 3 μm.

The carbon coating layer may be about 3 nm to about 300 nm thick.

The negative active material for a rechargeable lithium battery may include the carbon in an amount ranging from about 10 wt % to about 40 wt % based on the entire amount of negative active material.

In the negative active material for a rechargeable lithium battery, the carbon coating layer includes carbon in an amount ranging from about 70 wt % to about 80 wt % inside the pores, and also in an amount ranging from about 20 wt % to about 30 wt % on the surface of the nanostructure.

The negative active material for a rechargeable lithium battery may have a specific surface area ranging from about 2 m²/g to about 500 m²/g.

According to another embodiment of the present invention, provided is a rechargeable lithium battery including a negative electrode including the negative active material, a positive electrode including a positive active material, and an electrolyte.

Other aspects of the present invention are described in the detailed description.

According to one embodiment of the present invention, a method of preparing a negative active material for a rechargeable lithium battery includes an etching step using metal particles as a catalyst, and thus accomplishes excellent processing and economy. In addition, a negative active material for a rechargeable lithium battery prepared in the method includes a nanostructure and pores, and thus has a large specific surface area, resultantly bringing about an excellent capacity characteristic. In addition, it may mitigate a volume change during the charge and discharge, improving the cycle-life characteristic.

### BRIEF DESCRIPTION OF THE DRAWINGS

FIG. 1 is a SEM photograph showing a negative active material for a rechargeable lithium battery according to Example 1.

FIG. 2 is a SEM photograph enlargement of FIG. 1 by 40,000 times.

FIG. 3 is a SEM photograph showing the negative active material for a rechargeable lithium battery according to Example 1.

FIG. 4 is a SEM photograph showing a negative active material for a rechargeable lithium battery according to Example 2.

FIG. 5 is a SEM photograph showing a negative active material for a rechargeable lithium battery according to Example 3.

FIG. 6 is a TEM photograph showing a negative active material for a rechargeable lithium battery according to Example 1.

FIG. 7 is a TEM photograph enlargement of FIG. 6 by 100,000 times.

FIG. 8 is a TEM photograph enlargement of FIG. 6 by 250,000 times.

FIG. 9 is a FIB microscope photograph showing a negative active material for a rechargeable lithium battery according to Example 1.

FIG. 10 is a FIB microscope photograph showing the negative active material for a rechargeable lithium battery according to Example 1.

FIG. 11 is an X-ray diffraction analysis graph showing the negative active material for a rechargeable lithium battery according to Example 1.

### DETAILED DESCRIPTION OF THE EMBODIMENTS

Exemplary embodiments of the present disclosure will hereinafter be described in detail and can be easily performed by those who have common knowledge in the related art. However, these embodiments are only exemplary, and the present invention is not limited thereto.

According to one embodiment of the present invention, provided is a method of preparing a negative active material for a rechargeable lithium battery, which includes: providing a powder including a material being capable of doping and dedoping lithium; coating the powder including the material being capable of doping and dedoping lithium with metal particles; and etching the powder including the material being capable of doping and dedoping lithium and coated with the metal particles.

The method may further include coating the etched powder including the material being capable of doping and dedoping lithium with carbon.

The metal particles may work as a catalyst and selectively etch the powder including a material being capable of doping and dedoping lithium. In this way, a negative active material for a rechargeable lithium battery may be prepared in a simpler process, improving processing and economic properties. In addition, since the powder including a material being capable of doping and dedoping lithium is selectively etched to form pores, a negative active material for a rechargeable lithium battery prepared in the method has a larger specific surface area and thus an excellent capacity characteristic. In addition, it may mitigate a volume change during the charge and discharge, bringing about an excellent cycle-life characteristic.

The material being capable of doping and dedoping lithium may include one selected from the group consisting of silicon (Si), a Si—Y₁ alloy, tin (Sn), a Sn—Y₂ alloy, antimony (Sb), germanium (Ge), lead (Pb), and a combination thereof (wherein Y₁ and Y₂ are the same or different and are selected from the group consisting of an alkali metal, an alkaline-earth metal, a group 13 element, a group 14 element, a transition element, a rare earth element, and a combination thereof), provided that Y₁ is not silicon (Si) and Y₂ is not tin (Sn), but is not limited thereto. Among these materials, silicon (Si) may be used as a material being capable of doping and dedoping lithium.

Specifically, examples of Y₁ and Y₂ may include one selected from the group consisting of magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), silicon (Si), tin (Sn), indium (In), germanium (Ge), phosphorus (P), arsenic (As), antimony (Sb), bismuth (Bi), sulfur (S), selenium (Se), tellurium (Te), polonium (Po), and a combination thereof, but is not limited thereto.

The powder including a material being capable of doping and dedoping lithium may have an average particle diameter ranging from about 500 nm to about 100 μm. When the powder including a material being capable of doping and dedoping lithium has an average particle diameter within the range, it may be easily coated with metal particles on the surface. After the etching, the powder may be easily processed. Accordingly, when the powder is used to fabricate a rechargeable lithium battery, it may secure excellent processibility. In particular, the powder including a material being capable of doping and dedoping lithium may have an average particle diameter ranging from about 1 μm to about 50 μm.

First, the powder including a material being capable of doping and dedoping lithium may be coated with metal particles on the surface. The coating is performed in an electroless plating method, a physical vapor deposition (PVD) method, a chemical vapor deposition (CVD) method, a thermal deposition method, an e-beam evaporation method, a sputtering method, a method using an organic capping agent, or a combination thereof, but is not limited thereto. Among these methods, metal particles may be preferably coated by an electroless plating method.

The metal particles exist as particles on the surface of a powder including a material being capable of doping and dedoping lithium, and may play a role of a catalyst during the etching. Accordingly, the powder including a material being capable of doping and dedoping lithium is etched at the bottom where the metal particles exist, forming a nanostructure and pores therein.

The metal particles may include gold, silver, platinum, copper, nickel, aluminum, or a combination thereof, but are not limited thereto.

The metal particles may have an average particle diameter ranging from about 1 nm to about 100 nm. When the metal particles have an average particle diameter within the range, the following etching process may be effectively performed using the metal particles. Accordingly, the etching using the metal particles may form pores with a desired size and a nanostructure with a desired shape. In particular, the metal particles may have an average particle diameter ranging from about 1 nm to about 50 nm.

The metal particles may be partly or all connected to form a continuous film, but are not limited thereto.

Next, the powder including a material being capable of doping and dedoping lithium and coated with the metal particles is etched. The etching is performed along the crystal direction of the powder including a material being capable of doping and dedoping lithium. In addition, the etching may be performed where the powder including a material being capable of doping and dedoping lithium has a defect. This etching may form a nanostructure and pores in the powder including a material being capable of doping and dedoping lithium.

The etching may be performed using a mixed solution of hydrogen peroxide and fluorinated hydrogen, a hydrogen peroxide solution, a fluorinated hydrogen solution, a potassium hydroxide (KOH) solution, a mixed solution of potassium hydroxide (KOH) and isopropyl alcohol (IPA), or a combination thereof, but is not limited thereto as an etching solution.

For example, the powder including a material being capable of doping and dedoping lithium and coated with metal particles is dipped in the etching solution for etching to form a nanostructure and pores.

The etching solution may be regulated regarding concentration, use amount, and dipping time to control size and shape of a nanostructure and pores formed in the negative active material for a rechargeable lithium battery. When the powder including the material being capable of doping and dedoping lithium and coated with the metal particles is etched using the mixed solution of hydrogen peroxide and fluorinated hydrogen, the hydrogen peroxide may include a hydrogen peroxide aqueous solution in a concentration ranging from about 0.2% to about 10%, and the fluorinated hydrogen may include a fluorinated hydrogen aqueous solution in a concentration ranging from about 0.1% to about 20%. When the hydrogen peroxide aqueous solution and the fluorinated hydrogen aqueous solution have the above percentage concentrations, it may accelerate the etching speed, effectively controlling length and diameter of a nanostructure. In particular, the hydrogen peroxide may include a hydrogen peroxide aqueous solution in a concentration ranging from about 0.5% to about 6%, and the fluorinated hydrogen may include a fluorinated hydrogen aqueous solution in a concentration ranging from about 0.5% to about 10%.

Next, the etched powder including a material being capable of doping and dedoping lithium is washed. The washing step may remove a product from the reaction of a material being capable of doping and dedoping lithium with an etching solution, remaining metal particles within an etching solution, and remaining etching solution. For example, the washing may be performed by dipping the etched powder including a material being capable of doping and dedoping lithium in a solution including water, a nitric acid aqueous solution, alcohol, acetone, or a combination thereof. The washing step may be performed once or more than once, while alternating a washing solution. When it is performed more than once, the washing steps may include filtrating and drying steps therebetween. The drying may be performed under vacuum at a temperature ranging from about 100° C. to about 250° C., but is not limited thereto.

Next, the etched powder including a material being capable of doping and dedoping lithium is coated with carbon.

When the etched powder including a material being capable of doping and dedoping lithium is carbon-coated, it may bring about improved cycle-life characteristic and high rate characteristic of a rechargeable lithium battery, and prevent capacity fading.

For example, the carbon-coating of the etched powder including a material being capable of doping and dedoping lithium may be performed at a high temperature under an inert atmosphere or vacuum atmosphere by flowing hydrocarbon gas therein. Herein, the hydrocarbon gas may include acetylene gas, ethylene gas, or a combination thereof. The inert atmosphere may include an argon atmosphere. The high temperature may be in a range of about 500° C. to about 1000° C. However, the carbon coating is not limited thereto, but includes other methods and other materials. For example, the carbon source may include sucrose, glucose, polyacrylonitrile, polyvinyl alcohol, polyvinylpyrrolidone, colloidal carbon, citric acid, tartaric acid, glycolic acid, polyacrylic acid, adipic acid, glycine or a combination thereof, and the coating may be performed in a carbonization method, a spray pyrolysis method, a layer-by-layer assembly method, a dip coating method, or a combination thereof.

According to another embodiment of the present invention, a negative active material for a rechargeable lithium battery prepared in the method is provided.

The negative active material for a rechargeable lithium battery may include: a core including a material being capable of doping and dedoping lithium; a nanostructure formed on the surface of the core and including a material being capable of doping and dedoping lithium; and pores formed in the core, the nanostructure, among the nanostructures, or a combination thereof.

The negative active material may further include a carbon coating layer disposed on the surface of the nanostructure, the pores, or a combination thereof.

Herein, the material being capable of doping and dedoping lithium included in the core and the material being capable of doping and dedoping lithium included in the nanostructure may be the same.

The negative active material for a rechargeable lithium battery includes the nanostructure and thus has a big specific surface area, improving the capacity characteristic.

In addition, the pores formed in the core, the nanostructure, among the nanostructures, or a combination thereof included in the negative active material for a rechargeable lithium battery, may play a role in buffering against volume expansion and contraction of a material being capable of doping and dedoping lithium and preventing or mitigating its pulverization, and thus preventing or mitigating capacity fading. As a result, a negative active material for a rechargeable lithium battery according to one embodiment of the present invention may improve reversible capacity, coulomb efficiency, and rate capability and cycle-life characteristics of the rechargeable lithium battery.

The nanostructure may include nanowire, nanorods, nanotubes, nanoparticles, or a combination thereof, but is not limited thereto.

The nanostructure may have an aspect ratio ranging from about 1 to about 10,000. When the nanostructure has an aspect ratio within the range, it may prevent or mitigate pulverization due to volume expansion and contraction according to lithium intercalation and deintercalation. In addition, the nanostructure may help a negative active material easily react with lithium, effectively improving the high rate characteristic of a lithium rechargeable battery. In particular, the nanostructure may have an aspect ratio ranging from about 10 to about 1000.

The nanostructure may have a length ranging from about 100 nm to about 30 μm. When the nanostructure has a length within the range, a rechargeable lithium battery including the same may be easily manufactured. It may prevent or mitigate pulverization due to volume expansion and contraction according to lithium intercalation and deintercalation. In addition, the nanostructure may help a negative active material including the same easily react with lithium, effectively improving the high rate characteristic of a lithium rechargeable battery. In particular, the nanostructure may have a length ranging from about 300 nm to about 10 μm.

The nanostructure may have an average diameter ranging from about 1 nm to about 500 nm. When the nanostructure has an average diameter within the range, it may prevent or mitigate pulverization due to volume expansion and contraction according to lithium intercalation and deintercalation. In addition, the nanostructure may help a negative active material including the same easily react with lithium, effectively improving the high rate characteristic. In particular, the nanostructure may have an average diameter ranging from about 10 nm to about 200 nm.

The negative active material for a rechargeable lithium battery may include pores formed in the core, the nanostructure, among the nanostructures, or a combination thereof.

The pores formed in the core and the nanostructure may have an average diameter ranging from about 1 nm to about 100 nm. When the pores formed in the core and the nanostructure have an average diameter within the range, a negative active material including the pores may have a larger contact area with an electrolyte. Accordingly, lithium may easily approach the negative active material, effectively improving the high rate characteristic of a lithium rechargeable battery. In addition, the nanostructure may prevent or mitigate pulverization due to volume expansion and contraction according to lithium intercalation and deintercalation. In particular, pores formed in the core and the nanostructure may have an average diameter ranging from about 10 nm to about 50 nm.

The pores formed among the nanostructures may have an average diameter ranging from about 100 nm to about 2 μm. When the pores formed among the nanostructures have an average diameter within the range, a negative active material including the pores may have a larger contact area with an electrolyte. Accordingly, lithium may easily approach the negative active material, effectively improving the high rate characteristic. In addition, the nanostructure may prevent or mitigate pulverization due to volume expansion and contraction according to lithium intercalation and deintercalation. In particular, the pores among the nanostructures may have an average diameter ranging from about 300 nm to about 1 μm, and more particularly, from about 500 nm to about 800 nm.

In the negative active material for a rechargeable lithium battery, the pores formed in the core, the nanostructure, among the nanostructures, or a combination thereof may be nanopores with an average diameter ranging from about 1 nm to about 500 nm and micropores with an average diameter ranging from about 500 nm to about 3 μm. When the pores included in the negative active material for a rechargeable lithium battery include the aforementioned nanopores and micropores, it may prevent or mitigate pulverization due to volume expansion and contraction according to lithium intercalation and deintercalation. In particular, the pores formed in the core, the nanostructure, among the nanostructures, or a combination thereof may be nanopores with an average diameter ranging from about 10 nm to about 200 nm and micropores with an average diameter ranging from about 500 nm to about 1 μm.

Since the negative active material for a rechargeable lithium battery may include a carbon coating layer disposed on the surface of the nanostructure, the pores, or a combination thereof, the material being capable of doping and dedoping lithium may be prevented or mitigated from pulverization despite its volume change due to lithium intercalation and deintercalation. In addition, the material being capable of doping and dedoping lithium may not have a side-reaction with an electrolyte. In addition, the negative active material for a rechargeable lithium battery may have excellent conductivity and may easily react with lithium.

The coating layer may include amorphous carbon. Accordingly, when the material being capable of doping and dedoping lithium has a volume change due to lithium intercalation and deintercalation, it may effectively prevent or mitigate pulverization and a side-reaction with an electrolyte.

The coating layer is disposed on a part or the entire of surface of the nanostructure, the pores, or a combination thereof.

The carbon-coating layer may be about 3 nm to about 300 nm thick. When the carbon coating layer has a thickness within the range, the material being capable of doping and dedoping lithium may prevent or mitigate pulverization despite its volume change due to lithium intercalation and deintercalation and a side-reaction with an electrolyte. In addition, the negative active material for a rechargeable lithium battery may have excellent conductivity and may easily react with lithium. In particular, the carbon-coating layer may be about 3 nm to about 100 nm thick.

The negative active material for a rechargeable lithium battery may include the carbon in an amount ranging from about 10 wt % to about 40 wt % based on the entire amount of the negative active material for a rechargeable lithium battery. When the negative active material for a rechargeable lithium battery include carbon within the range, the material being capable of doping and dedoping lithium may prevent or mitigate pulverization despite a volume change, and a side-reaction with an electrolyte, and thus may decrease non-conductive solid-electrolyte interface (SEI) formation. Accordingly, it may decrease an amount of irreversibly consumed lithium due to SEI formation and effectively improve coulomb efficiency and the cycle-life characteristic. In particular, the negative active material for a rechargeable lithium battery may include the carbon in an amount ranging from about 10 wt % to about 25 wt % based on the entire amount of the negative active material for a rechargeable lithium battery.

The carbon coating layer includes carbon in an amount ranging from about 70 wt % to about 80 wt % inside the pores and from about 20 wt % to about 30 wt % on the surface of the nanostructure, for example, outside of the pores. When the carbon coating layer includes carbon within the range, the material being capable of doping and dedoping lithium may effectively prevent or mitigate pulverization despite the volume change due to lithium intercalation and deintercalation and a side-reaction with an electrolyte, and thus may decrease non-conductive SEI formation. Accordingly, it may decrease an amount of irreversibly-consumed lithium due to SEI formation and effectively improve coulomb efficiency and cycle-life characteristic.

The negative active material for a rechargeable lithium battery may have a specific surface area ranging from about 2 m²/g to about 500 m²/g. When the negative active material for a rechargeable lithium battery has a specific surface area within the range, it may effectively improve the capacity characteristic and high rate characteristic and decrease a side-reaction with an electrolyte, and thus decrease non-conductive SEI formation. Accordingly, it may decrease an amount of irreversibly consumed lithium due to SEI formation and thus improve coulomb efficiency and the cycle-life characteristic. In particular, the negative active material for a rechargeable lithium battery may have a specific surface area ranging from about 5 m²/g to about 300 m²/g.

The negative active material according to one embodiment of the present invention may be usefully applied to a negative electrode for an electrochemical cell like a rechargeable lithium battery. The rechargeable lithium battery may include a positive electrode including a positive active material and an electrolyte, as well as the negative electrode.

The negative electrode is fabricated by mixing a negative active material of the present invention, a conductive material, a binder, and a solvent to prepare a negative active material composition, then directly coating it on a copper current collector and drying it. Alternatively, the negative active material composition is coated on a separate supporter and then peeled off from the supporter. Then, the film is laminated on a copper current collector.

The conductive material includes carbon black, graphite, and a metal powder, but is not limited thereto. The binder includes a vinylidene fluoride/hexafluoropropylene copolymer, polyvinylidene fluoride, polyacrylonitrile, polymethylmethacrylate, polytetrafluoroethylene, and mixtures thereof, but is not limited thereto. The solvent includes N-methylpyrrolidone, acetone, tetrahydrofuran, decane, and the like, but is not limited thereto. Herein, the amounts of the negative active material, the conductive material, the binder, and the solvent are the same as commonly used in a rechargeable lithium battery.

Like the negative electrode, the positive electrode is fabricated by preparing a positive active material composition by mixing a positive active material, a binder, and a solvent, and coating the composition on an aluminum current collector or coating it on a separate supporter, peeling it, and then laminating the film on an aluminum current collector. Herein, the positive active material composition may further include a conductive material, if necessary.

The positive active material may include a material that can intercalate/deintercalate lithium, for example, a metal oxide, a lithium composite metal oxide, a lithium composite metal sulfide, a lithium composite metal nitride, and the like, but is not limited thereto.

Non-limiting examples of the separator materials include polyethylene, polypropylene, and polyvinylidene fluoride, and a multi-layer thereof such as a polyethylene/polypropylene double-layered separator, a polyethylene/polypropylene/polyethylene triple-layered separator, and a polypropylene/polyethylene/polypropylene triple-layered separator can be used.

The electrolyte charged for a rechargeable lithium battery may include a non-aqueous electrolyte, a solid electrolyte, or the like, in which a lithium salt is dissolved.

The solvent for a non-aqueous electrolyte includes, but is not limited to, cyclic carbonates such as ethylene carbonate, diethylene carbonate, propylene carbonate, butylene carbonate, vinylene carbonate, and the like, linear carbonates such as dimethyl carbonate, ethylmethyl carbonate, diethyl carbonate, and the like, esters such as methyl acetate, ethyl acetate, propyl acetate, methyl propionate, ethyl propionate, γ-butyrolactone, and the like, ethers such as 1,2-dimethoxyethane, 1,2-diethoxyethane, tetrahydrofuran, 1,2-dioxane, 2-methyltetrahydrofuran, nitriles such as acetonitrile, and amides such as dimethyl formamide, but is not limited thereto. They may be used singularly or in plural. In particular, it may include a mixed solvent of a cyclic carbonate and a linear carbonate.

In addition, the electrolyte may include a gel-type polymer electrolyte prepared by impregnating an electrolyte solution in a polymer electrolyte such as polyethylene oxide, polyacrylonitrile, and the like, or an inorganic solid electrolyte such as Lil and Li₃N, but is not limited thereto.

The lithium salt includes at least one selected from the group consisting of LiPF₆, LiBF₄, LiSbF₆, LiAsF₆, LiClO₄, LiCF₃SO₃, Li(CF₃SO₂)₂N, LiC₄F₉SO₃, LiSbF₆, LiAlO₄, LiAlO₂, LiAlCl₄, LiCl, and Lil, but is not limited thereto.

### EXAMPLE

The following examples illustrate the present invention in more detail. However, it is understood that the present invention is not limited by these examples.

### Example 1

### Preparation of a Negative Active Material for a Rechargeable Lithium Battery

A silicon powder with a particle diameter of 40 μm is prepared.

Next, 20 ml of a fluorinated hydrogen aqueous solution with a concentration of 10% and 20 ml of 10 mM nitric acid aqueous solution are mixed to prepare a mixture. The mixture is put in a 500 ml beaker, and 2 g of the silicon powder is added thereto, and then these are reacted for 3 minutes. In this way, silver particles are coated on the surface of the silicon powder in an electroless plating method.

Next, the silicon powder coated with silver particles is washed away five times with an excess amount of water to remove silver uncoated with silicon powder and impurities. Then, the silicon powder coated with silver particles is filtrated using a polypropylene (PP) filter. The filtrate is dried at 150° C. under vacuum for one hour, preparing silicon powder coated with silver.

On the other hand, 100 ml of a fluorinated hydrogen aqueous solution with a concentration of 10% and 100 ml of a hydrogen peroxide aqueous solution with a concentration of 1.2% are put in a 500 ml beaker. The mixture is agitated, preparing an etching solution.

The etching solution is heated to 50° C., and 2 g of the silicon powder coated with silver is added thereto. The mixture is reacted for 3 hours. Accordingly, the silicon powder may be catalytically etched as shown in the following Reaction scheme 1, and includes a nanostructure and pores. In other words, since silver works as a catalyst, the silicon powder is etched where it contacts the silver particles vertically along the crystal direction while it is not etched where it does not contact the silver particles, and thus has a nanostructure and pores. In addition, the silicon powder is etched where it has a defect, resultantly having pores.

Si+2H₂O₂+6HF+Ag→H₂SiF₆+4H₂O+Ag [Reaction Scheme 1]

Next, the resulting product is washed five times with an excess amount of water to remove a product from reaction of silicon with an etching solution and remaining fluorinated hydrogen and hydrogen peroxide. Then, the solution including the etched silicon powder is filtrated. The filtrate is dried at 150° C. under vacuum for one hour.

The resulting product is washed for 2 hours with an excess amount of a nitric acid aqueous solution heated to 50° C. and having a concentration of 69% to remove remaining silver. In this way, silicon powder having a nanostructure and pores is prepared.

The silicon powder including a nanostructure and pores is heated to 900° C. under a vacuum atmosphere while acetylene gas flows thereto, forming a carbon coating layer. The silicon powder including a nanostructure and pores and having the carbon coating layer is used as a negative active material for a rechargeable lithium battery. Herein, the negative active material for a rechargeable lithium battery includes 25 wt % of carbon based on the entire amount of the negative active material for a rechargeable lithium battery.

### Example 2

### Preparation of a Negative Active Material for a Rechargeable Lithium Battery

Silicon powder including a nanostructure and pores and having a carbon coating layer is prepared according to the same method as Example 1, except for using a hydrogen peroxide aqueous solution with a concentration of 1.5% instead of a hydrogen peroxide aqueous solution with a concentration of 1.2%. This silicon powder is used as a negative active material for a rechargeable lithium battery.

### Example 3

### Negative Active Material for a Rechargeable Lithium Battery

Silicon powder including a nanostructure and pores and having a carbon coating layer is prepared according to the same method as Example 1, except for using a hydrogen peroxide aqueous solution with a concentration of 2.0% instead of a hydrogen peroxide aqueous solution with a concentration of 1.2%. Then, the silicon powder is used as a negative active material for a rechargeable lithium battery.

### Example 4

### Fabrication of a Rechargeable Lithium Battery

The negative active material for a rechargeable lithium battery according to Example 1, Super-P carbon black, and polyvinylidene fluoride (PVdF) are mixed in a weight ratio of 80:10:10 in an N-methylpyrrolidone solvent, preparing a negative active material slurry. The negative active material slurry is coated to be 50 μm thick on a copper foil, vacuum-dried at 150° C. for 20 minutes, and roll-pressed, fabricating a negative electrode. The negative active material is loaded in an amount of 9 mg/cm². Herein, 0.2 C (900 mA/g) is equivalent to 8.1 mA/cm².

The negative electrode is used with a lithium foil as a counter electrode and a 25 μm-thick microporous polyethylene film (Celgard 2300, Celgard LLC) as a separator to fabricate a half-coin cell (2016 R-type half cell) in a common manufacturing process. Herein, a liquid electrolyte solution is prepared by dissolving LiPF₆ in a concentration of 1M in a solvent prepared by mixing ethylene carbonate and dimethyl carbonate in a volume ratio of 50:50 is used.

### Example 5

### Fabrication of a Rechargeable Lithium Battery

A half-coin cell is fabricated according to the same method as Example 4, except for using a negative active material for a rechargeable lithium battery according to Example 2 instead of the negative active material for a rechargeable lithium battery according to Example 1.

### Example 6

### Fabrication of a Rechargeable Lithium Battery Cell

A half-coin cell is fabricated according to the same method as Example 4, except for using a negative active material for a rechargeable lithium battery according to Example 3 instead of the negative active material for a rechargeable lithium battery according to Example 1.

### Comparative Example 1

### Preparation of a Negative Active Material for a Rechargeable Lithium Battery

A silicon powder with a particle diameter of 40 μm is prepared, and a carbon coating layer is disposed thereon by heating the silicon powder to 900° C. while acetylene gas flows into the silicon powder. Then, the resulting product is used as a negative active material for a rechargeable lithium battery. Herein, the negative active material for a rechargeable lithium battery includes carbon in an amount of 25 wt % based on the entire amount.

### Comparative Example 2

### Fabrication of a Rechargeable Lithium Battery Cell

A half-coin cell is fabricated according to the same method as Example 4, except for using a negative active material for a rechargeable lithium battery according to Comparative Example 1 instead of the negative active material for a rechargeable lithium battery according to Example 1.

### Experimental Example 1

### Scanning Electron Microscope (SEM) Photograph

The negative active materials for a rechargeable lithium battery according to Example 1 to 3 are respectively deposited on a carbon-coated copper grid to prepare a specimen. The specimen is photographed with an SEM. Herein, a field emission gun scanning electron microscope (FEG-SEM) JSM-6390 (JEOL Ltd.) is used.

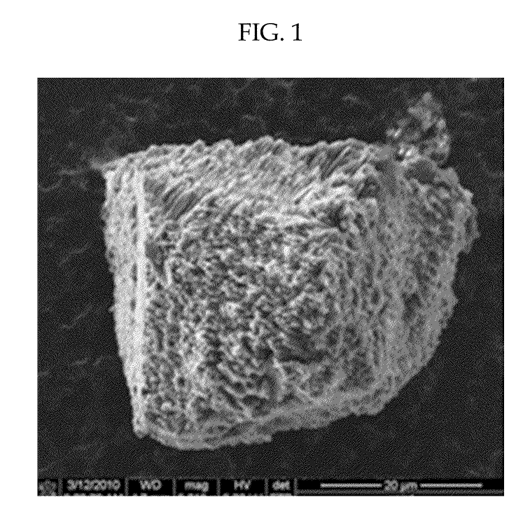

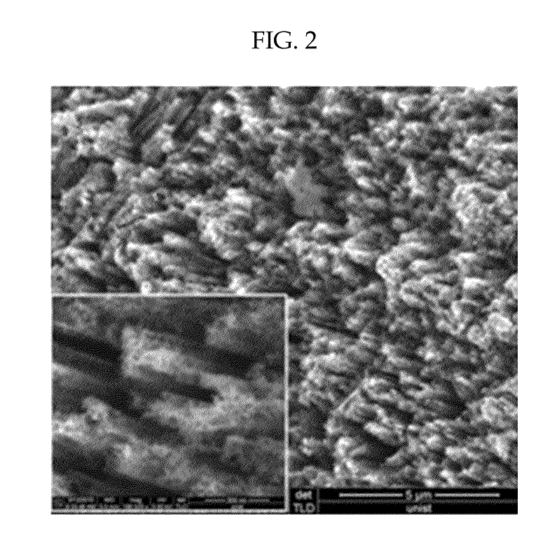

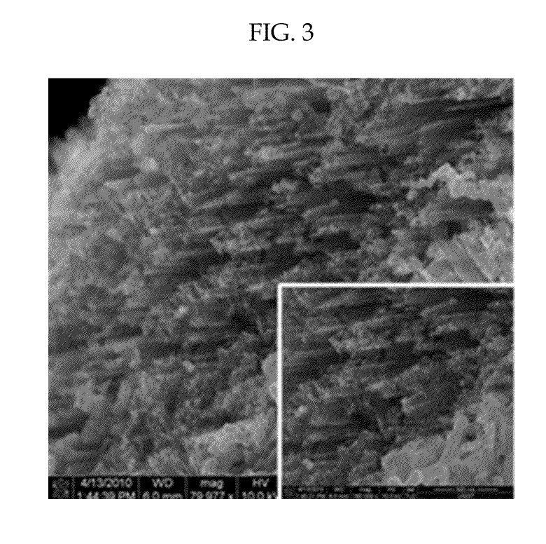

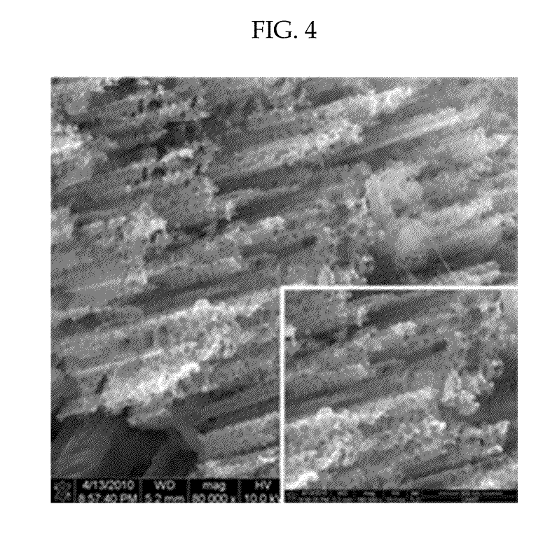

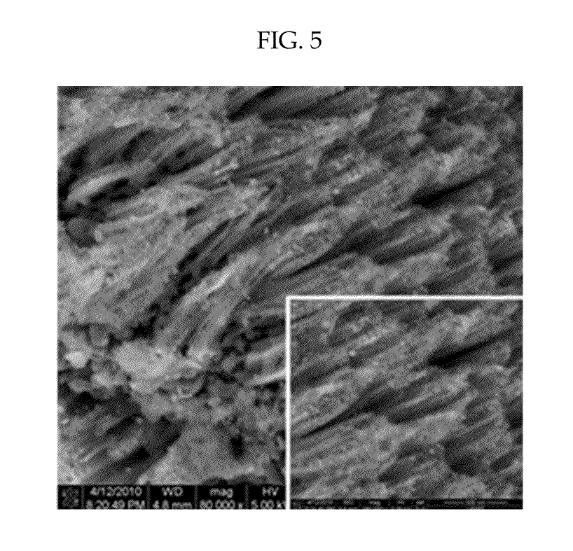

FIGS. 1, 2, and 3 show SEM photographs of the negative active material for a rechargeable lithium battery according to Example 1. FIG. 2 is a photograph enlargement of the one of FIG. 1 by 40,000 times. In addition, FIG. 4 is a SEM photograph showing the negative active material for a rechargeable lithium battery according to Example 2. FIG. 5 is a SEM photograph showing the negative active material for a rechargeable lithium battery according to Example 3.

As shown in FIGS. 1 to 5, the negative active materials for a rechargeable lithium battery according to Examples 1 to 3 are identified to have a core including nanowires including silicon on the surface of the core.

In addition, as a hydrogen peroxide aqueous solution is increasingly included in concentration, the nanowire includes more pores on the surface. More pores bring about a larger specific surface area of the nanowire, effectively improving the capacity characteristic.

### Experimental Example 2

### Transmission Electron Microscope (TEM) Photograph

The negative active materials for a rechargeable lithium battery according to Examples 1 to 3 are respectively treated for about 10 minutes in an ultrasonic grinder, and then deposited on a carbon-coated copper grid, preparing a specimen. The specimen is photographed with a TEM. Herein, a field-emission transmission electron microscope (FE-TEM) working at 200 kV (2010F, JEOL Ltd.) is used.

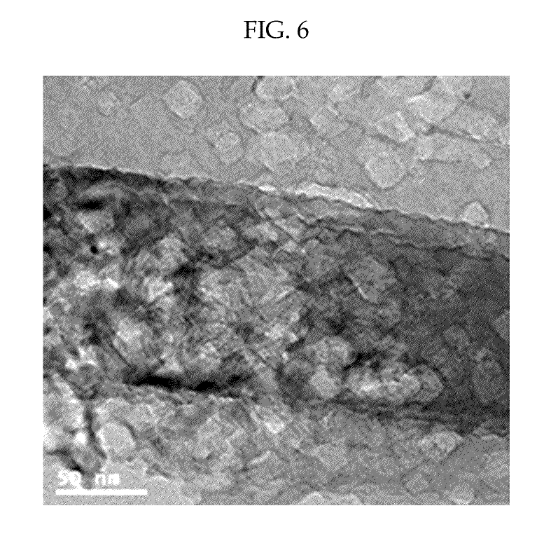

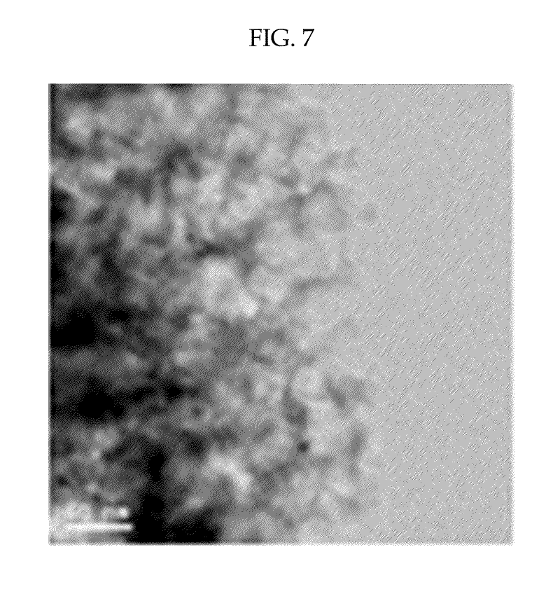

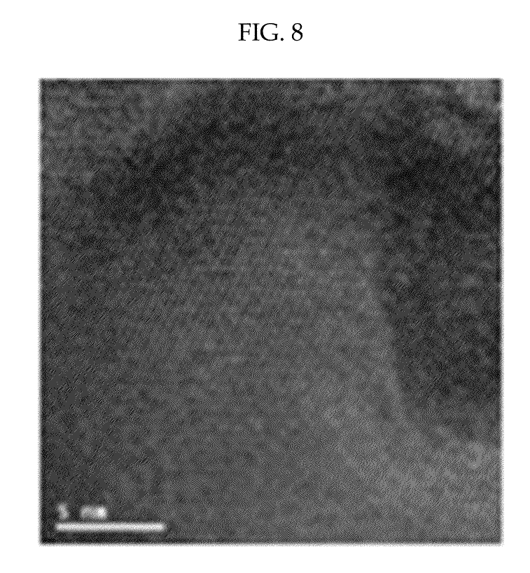

FIG. 6 shows a TEM photograph of the negative active material for a rechargeable lithium battery according to Example 1, FIG. 7 shows a 100,000 times enlargement of the TEM photograph of the negative active material for a rechargeable lithium battery according to Example 1, and FIG. 8 shows a 250,000 times enlargement of the TEM photograph of the negative active material for a rechargeable lithium battery according to Example 1.

As shown in FIGS. 6 to 8, the negative active material for a rechargeable lithium battery according to Example 1 is identified to include a core including silicon, nanowire including silicon on the surface of the core, and pores formed in the nanowire. In addition, the pores in the nanowire have an average diameter ranging from about 20 nm to about 30 nm.

The nanowire and pores are prepared by etching silicon powder and the defect of the silicon powder in the etching solution using silver particles as a catalyst.

### Experimental Example 3

### Focused Ion Beam (FIB) Electron Microscope Photograph

The negative active materials for a rechargeable lithium battery according to Examples 1 to 3 are respectively deposited on a carbon-coated copper grid, preparing a specimen. The cross-section of the specimen is photographed with a focused ion beam (FIB) microscope. Herein, a dual-beam focused ion beam (Quanta 3D FEG) microscope is used.

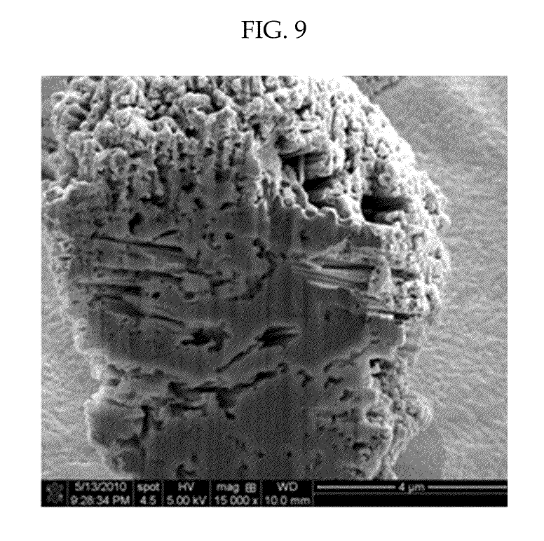

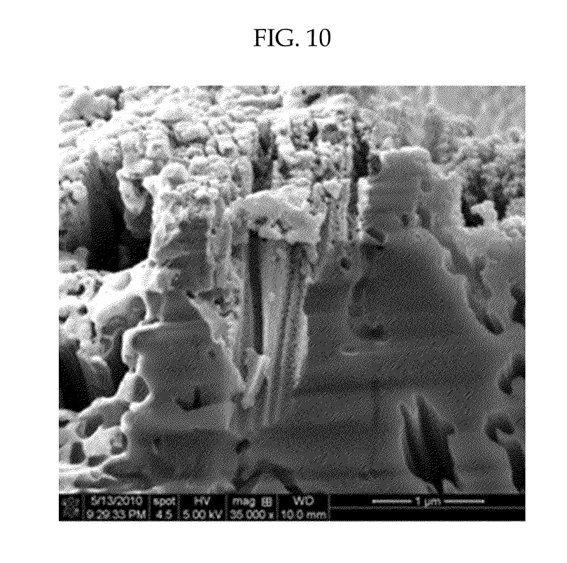

FIGS. 9 and 10 show FIB microscope photographs of the negative active material for a rechargeable lithium battery according to Example 1.

As shown in FIGS. 9 and 10, the negative active material for a rechargeable lithium battery according to Example 1 is identified to have nanowire etched in various directions. The etching has a depth ranging from about 3 μm to about 6 μm, and accordingly, the nanowire has a length ranging from about 3 μm to about 6 μm. In addition, the nanowire is identified to include fine pores.

The reason that the etching is performed in various directions and the nanowire has length differences is because silicon powder has various crystal directions and is etched in various degrees depending on each crystal direction.

### Experimental Example 4

### X-Ray Diffraction Analysis

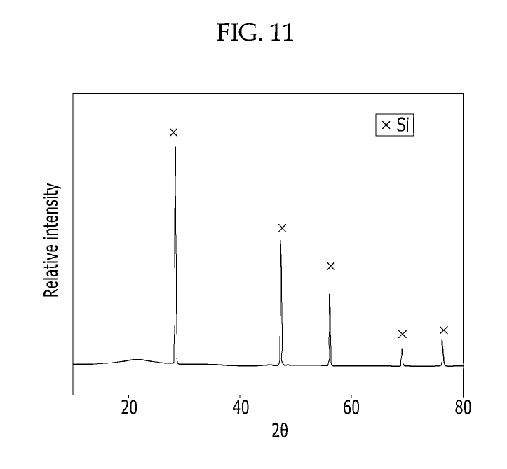

The negative active materials for a rechargeable lithium battery according to Examples 1 to 3 are evaluated by X-ray diffraction analysis. FIG. 11 shows the X-ray diffraction analysis result of the negative active material for a rechargeable lithium battery according to Example 1.

In the X-ray diffraction analysis, a Cu—Kα ray is used as a light source.

As shown in FIG. 11, the negative active material for a rechargeable lithium battery according to Example 1 is identified to include monocrystalline silicon. A gentle peak of 2θ value around 20° shows amorphous SiO₂, which is naturally-oxidized silica (SiO₂).

### Experimental Example 5

### Initial Charge Capacity, Initial Discharge Capacity, and Coulomb Efficiency Measurements

The half-cells according to Examples 4 to 6 and Comparative Example 2 are charged and discharged once at 0.01 V to 1.2 V with a 0.1 C rate, and then evaluated regarding initial charge capacity, initial discharge capacity, and coulomb efficiency.

The half-cell of Example 4 has initial charge capacity of 3950 mAh/g and initial discharge capacity of 3470 mAh/g, and thus coulomb efficiency of 87.8%.

The half-cell of Example 5 has initial charge capacity of 3200 mAh/g and initial discharge capacity of 2630 mAh/g, and thus coulomb efficiency of 82.2%.

The half cell of Example 6 has initial charge capacity of 3100 mAh/g and initial discharge capacity of 2620 mAh/g, and thus coulomb efficiency of 84.5%.

The half-cell of Comparative Example 2 has initial charge capacity of 3150 mAh/g and initial discharge capacity of 1000 mAh/g, and thus coulomb efficiency of 31.7%.

As shown above, the half-cells according to Examples 4 to 6 have excellent properties, since the negative active materials for rechargeable lithium batteries according to Examples 1 to 3 include a nanostructure and pores and thus have a larger specific surface area, mitigating their volume change during the charge and discharge.

### Experimental Example 6

### Cycle-Life Characteristic

The half-cells according to Examples 4 to 6 and Comparative Example 2 are charged and discharged 20 times at 0.01 V to 1.2 V with a 0.1 C rate and then measured regarding discharge capacity. The results are provided in the following Table 1.

TABLE 1

| | 1st discharge | 20th discharge | Capacity |
|---|---|---|---|
| | capacity (mAh/g) | capacity (mAh/g) | retention (%) |
| Example 4 | 3470 | 2200 | 66.3 |
| Example 5 | 2630 | 2100 | 79.8 |
| Example 6 | 2620 | 2050 | 78.2 |
| Comparative | 1000 | 0 | 0 |
| Example 2 | | | |

As shown in Table 1, the half-cells according to Examples 4 to 6 have excellent cycle-life characteristics, since the negative active materials for rechargeable lithium batteries according to Examples 1 to 3 include a nanostructure and pores and thus have a larger specific surface area, resultantly mitigating their volume change during the charge and discharge.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims. Therefore, the aforementioned embodiments are exemplary but not limiting in any way.

What is claimed is:

1. A method of preparing a negative active material for a rechargeable lithium battery, comprising
providing a powder including a material being capable of doping and dedoping lithium;
coating the powder including the material being capable of doping and dedoping lithium with metal particles; and
etching the powder including the material being capable of doping and dedoping lithium and coated with the metal particles.

2. The method of claim 1, further comprising
coating the etched powder including the material being capable of doping and dedoping lithium with carbon.

3. The method of claim 1, wherein the material being capable of doping and dedoping lithium comprises one selected from the group consisting of silicon (Si), a Si—Y₁ alloy, tin (Sn), a Sn—Y₂ alloy, antimony (Sb), germanium (Ge), lead (Pb), and a combination thereof (wherein Y₁ and Y₂ are the same or different and are selected from the group consisting of an alkali metal, an alkaline-earth metal, a group 13 element, a group 14 element, transition elements, a rare earth element, and a combination thereof), provided that Y₁ is not silicon (Si) and Y₂ is not tin (Sn).

4. The method of claim 1, wherein the powder including a material being capable of doping and dedoping lithium has an average particle diameter ranging from 500 nm to 100 μm.

5. The method of claim 1, wherein the powder including the material being capable of doping and dedoping lithium is coated with metal particles in an electroless plating method, a physical vapor deposition (PVD) method, a chemical vapor deposition (CVD) method, a thermal deposition method, an e-beam evaporation method, a sputtering method, a method using an organic capping agent, or a combination thereof.

6. The method of claim 1, wherein the metal particles comprise gold, silver, platinum, copper, nickel, aluminum, or combination thereof.

7. The method of claim 1, wherein the metal particles have an average particle diameter ranging from 1 nm to 100 nm.

8. The method of claim 1, wherein the powder comprising the material being capable of doping and dedoping lithium and coated with the metal particles is etched using a mixed solution of hydrogen peroxide and fluorinated hydrogen, a hydrogen peroxide solution, a fluorinated hydrogen solution, a potassium hydroxide (KOH) solution, a mixed solution of potassium hydroxide (KOH) and isopropyl alcohol (IPA), or a combination thereof.

9. The method of claim 8, wherein the fluorinated hydrogen comprises a fluorinated hydrogen aqueous solution in a concentration of 0.1% to 20%.

10. A negative active material comprising:
a core comprising a material being capable of doping and dedoping lithium;
a nanostructure formed on the surface of the core and comprising a material being capable of doping and dedoping lithium; and
pores formed in the core, the nanostructure, among the nanostructures, or combination thereof.

11. The negative active material of claim 10, further comprising
the carbon coating layer formed on the surface of the nanostructure, the pores, or a combination thereof.

12. The negative active material of claim 10, wherein the nanostructure comprises nanowire, nanorods, nanotubes, nanoparticles, or a combination thereof.

13. The negative active material of claim 10, wherein the nanostructure has an aspect ratio ranging from 1 to 10,000.

14. The negative active material of claim 10, wherein the nanostructure has a length ranging from 100 nm to 30 μm.

15. The negative active material of claim 10, wherein the nanostructure has an average diameter ranging from 1 nm to 500 nm.

16. The negative active material of claim 10, wherein the pores formed among the nanostructures have an average diameter ranging from 100 nm to 2 μm.

17. The negative active material of claim 10, wherein the pores comprise nanopores with an average diameter ranging from 1 nm to 500 nm and micropores with an average diameter ranging from 500 nm to 3 μm.

18. The negative active material of claim 10, wherein the carbon coating layer has a thickness ranging from 3 nm to 300 nm.

19. The negative active material of claim 10, which has a specific surface area ranging from 2 m²/g to 500 m²/g.

20. A rechargeable lithium battery comprising:
a negative electrode comprising a negative active material;
a positive electrode including a positive active material; and
an electrolyte,
wherein the negative active material is a negative active material for a rechargeable lithium battery according to claim 10.
